(19) United States
(12) Patent Application Publication
(10) Pub. No.: US 2010/0289366 A1
(43) Pub. Date: Nov. 18, 2010

(54) Rare Earth Magnet and Motor Using the Same

(75) Inventors: Matahiro KOMURO, Hitachi (JP); Yuichi SATSU, Hitachi (JP); Hiroyuki SUZUKI, Hitachi (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Tokyo (JP)

(21) Appl. No.: 12/777,738

(22) Filed: May 11, 2010

(30) Foreign Application Priority Data
May 12, 2009 (JP) 2009-115081

(51) Int. Cl. H02K 21/12; H01F 7/02

(52) U.S. Cl. 310/156.01; 335/302

(57) ABSTRACT

The present invention makes it possible to increase the residual magnetic flux density and the coercive force of a rare earth magnet; and raise the Curie temperature. In a magnet formed by compressing magnetic particles, the surface of a magnetic particle is covered with a metal fluoride film, the magnetic particle has a crystal structure containing a homo portion formed by bonding adjacent iron atoms and a hetero portion formed by bonding two iron atoms via an atom other than iron, and the distance between the two iron atoms in the hetero portion is different from the distance between the adjacent iron atoms in the homo portion.

### CLAIM OF PRIORITY

The present application claims priority from Japanese Patent application serial No. 2009-115081, filed on May 12, 2009, the content of which is hereby incorporated by reference into this application.

### BACKGROUND OF THE INVENTION

1. Field of the Invention

The present invention relates to a rare earth magnet and a motor using the rare earth magnet.

2. Description of Related Art

Conventional rare earth sintered magnets containing fluorine compounds or oxidized fluorine compounds are described in Patent Literature 1 (Japanese Patent Application Laid-Open No. 2003-282312), Patent Literature 2 (Japanese Patent Application Laid-Open No. 2006-303433), Patent Literature 3 (Japanese Patent Application Laid-Open No. 2006-303434), Patent Literature 4 (Japanese Patent Application Laid-Open No. 2006-303435), Patent Literature 5 (Japanese Patent Application Laid-Open No. 2006-303436), and Patent Literature 6 (Japanese Patent Application Laid-Open No. 2008-270699).

Patent Literature 1 discloses an R—Fe—(B, C) series sintered magnet (here, R represents a rare earth element and the content of Nd and/or Pr accounts for 50% or more of R) having an improved polarization, in which a granular grain boundary phase is formed at a crystal grain boundary or a grain boundary triple point of a main phase mainly comprising Nd₂Fe₁₄B type crystal; the grain boundary phase contains a fluorine compound of the rare earth element; and the content of the rare earth element fluorine compound is in the range of 3 to 20 weight % of the whole sintered magnet.

Patent Literature 2 discloses a rare earth permanent magnet being a sintered magnet having a composition of R¹ₐR²_{b}T_{c}A_{d}FₑO_{f}M_{g} (R¹ contains Sc and Y and represents one or more kinds selected from rare earth elements except Tb and Dy, R² represents one or two kinds selected from Tb and Dy, T represents one or two kinds selected from Fe and Co, A represents one or two kinds selected from B and C, and M represents one or more kinds selected from the group consisting of Al, Cu, Zn, In, Si, P, S, Ti, V, Cr, Mn, Ni, Ga, Ge, Zr, Nb, Mo, Pd, Ag, Cd, Sn, Sb, Hf, Ta and W), in which F and R² being constituent elements of the sintered magnet distribute so that the concentration of the content may averagely increase from the center toward the surface of the magnet; at a crystal grain boundary portion surrounding a main phase crystal grain comprising (R¹, R²)₂T₁₄A tetragon in the sintered magnet, the concentration of R²/(R¹+R²) contained in the crystal grain boundary is averagely higher than the concentration of R²/(R¹+R²) contained in the main phase crystal grain; and oxidized fluoride of (R¹, R²) exists at the crystal grain boundary portion up to the region at least 20 μm in depth from the surface of the magnet at the crystal grain boundary portion.

Patent Literature 3 discloses a functionally gradient rare earth permanent magnet of a low eddy-current loss that is obtained by absorbing an E component (E represents one or more kinds selected from alkali earth metal elements and rare earth elements) and fluorine atoms into an R—Fe—B series (R represents rare earth elements including Sc and Y) sintered magnet from the surface thereof and is a sintered magnet having a composition shown by the chemical formulae (1) or (2) below, in which F being a constituent element of the sintered magnet distributes so that the concentration of the content may averagely increase from the center toward the surface of the magnet; at a crystal grain boundary portion surrounding a main phase crystal grain comprising (R, E)₂T₁₄A tetragon in the sintered magnet, the concentration of E/(R+E) contained in the crystal grain boundary is averagely higher than the concentration of E/(R+E) contained in the main phase crystal grain; oxidized fluoride of (R, E) exists at the crystal grain boundary portion up to the region at least 20 μm in depth from the surface of the magnet at the crystal grain boundary portion; oxidized fluoride grains 1 μm or more in circle equivalent diameter disperse at the rate of 2,000 pieces or more per 1 square millimeter in the region; the content of the oxidized fluoride accounts for 1% or more in area fraction; and the electrical resistance of the magnet surface portion is higher than that of the magnet interior;

RₐE_{b}T_{c}A_{d}FₑO_{f}M_{g} (1)

(R·E)_{a+b}T_{c}A_{d}FₑO_{f}M_{g} (2).

(In the chemical formulae, R represents one or more kinds selected from rare earth elements including Sc and Y, and E represents one or more kinds selected from alkali earth metal elements and rare earth elements, but R and E may contain identical elements. Then, when R and E contain no identical elements, the composition is expressed by the chemical formula (1), and when R and E contain identical elements, the composition is expressed by the chemical formula (2). T represents one or two kinds selected from Fe and Co, A represents one or two kinds selected from B and C, and M represents one or more kinds selected from the group consisting of Al, Cu, Zn, In, Si, P, S, Ti, V, Cr, Mn, Ni, Ga, Ge, Zr, Nb, Mo, Pd, Ag, Cd, Sn, Sb, Hf, Ta and W.)

Patent Literature 4 discloses a functionally gradient rare earth permanent magnet being a sintered magnet having a composition of R¹ₐR²_{b}T_{c}A_{d}FₑO_{f}M_{g}, in which R² distributes so that the concentration of R²/(R¹+R²) contained in a crystal grain boundary may be averagely higher than the concentration of R²/(R¹+R²) contained in a main phase crystal grain and the concentration of R² may averagely increase from the center toward the surface of the magnet; oxidized fluoride of (R¹, R²) exists at the crystal grain boundary portion up to the region at least 20 μm in depth from the surface of the magnet at the crystal grain boundary portion; and the coercive force of the magnet surface portion is higher than that of the magnet interior at the crystal grain boundary portion surrounding the main phase crystal grain comprising (R¹, R²)₂T₁₄A tetragon in the sintered magnet.

Patent Literature 5 discloses a rare earth permanent magnet being a sintered magnet having a composition of R¹ₐR²_{b}T_{c}A_{d}FₑO_{f}M_{g}, in which F and R² being constituent elements of the sintered magnet distribute so that the concentration of the content may averagely increase from the center toward the surface of the magnet; and a crystal grain boundary having an R²/(R¹+R²) concentration averagely higher than an R²/(R¹+R²) concentration in a main phase crystal grain consisting of (R, E)₂T₁₄A tetragon is shaped in a three-dimensional mesh pattern continuously up to the depth of at least 10 μm from the magnet surface.

Patent Literature 6 discloses a magnet formed of a magnetic material containing iron and a rare earth element, in which a plurality of fluorine compound layers or oxidized fluorine compound layers are formed in the interior of the magnetic material; and the fluorine compound layers or the oxidized fluorine compound layers have long axes larger than the average grain size of crystal grains of the magnetic material.

Non-Patent Literature 1 (PHYSICAL REVIEW B, pp. 3296-3303 (1996)) describes that local magnetic moment and others are computed, and geometrical effect by uniform volume expansion and chemical effect by the combination of adjacent iron atoms and atoms at a grain boundary are studied separately with regard to Gd₂Fe₁₇ being a pure material and Gd₂Fe₁₇Z₃ (Z=C, N, O or F) being a grain boundary compound.

### SUMMARY OF THE INVENTION

An object of the present invention is to increase a residual magnetic flux density and a coercive force of a rare earth magnet and heighten Curie temperature thereof.

A magnet according to the present invention is a magnet formed by compressing magnetic particles, in which a surface of the magnetic particles is covered with a metal fluoride film; the magnetic particles have a crystal structure containing a homo portion formed by bonding adjacent iron atoms and a hetero portion formed by bonding two iron atoms via an atom other than iron; and the distance between the two iron atoms in the hetero portion is different from the distance between the adjacent iron atoms in the homo portion.

### BRIEF DESCRIPTION OF THE DRAWINGS

FIG. 1 is a pattern diagram showing a crystal structure (a body centered cubic crystal structure) of a conventional magnet.

FIG. 2 is a pattern diagram showing a crystal structure of a magnet of an example according to the present invention.

FIG. 3 is a schematic sectional view showing a structure of a magnetic particle constituting a magnet of an example according to the present invention.

FIG. 4 is a graph showing an X-ray diffraction pattern of a magnet of an example according to the present invention.

FIG. 5 is a sectional view showing a magnet motor to which a magnet of an example according to the present invention is applied.

FIG. 6 is a graph showing the relationship between a magnetization and a magnetic field in a magnet of an example according to the present invention.

FIGS. 7A and 7B are schematic sectional views showing the structures in the vicinities of an interface of a magnetic particle of an example according to the present invention.

FIGS. 8A and 8B are graphs showing the distributions of elements in the vicinities of surfaces of magnets of an example according to the present invention.

### DETAILED DESCRIPTION OF THE PREFERRED EMBODIMENTS

The present invention relates to a rare earth magnet and a production method thereof; and in particular to a motor using a magnet that decreases the usage of a heavy rare earth element and has a high energy product or a high thermal resistance.

In a sintered rare earth magnet using fluoride according to a conventional technology, pulverized particles of a fluorine compound and the like are used as a raw material in order to form a laminar phase containing fluorine in an NdFeB magnetic particle, a heavy rare earth element is unevenly distributed on the outer circumferential side of an NdFeB crystal grain, and thereby a coercive force is enhanced. A residual magnetic flux density lowers however when the usage of the heavy rare earth element is increased, but the usage is decreased by unevenly distributing the heavy rare earth element in the vicinity of a grain boundary.

Magnetization in the vicinity of the grain boundary decreases by unevenly distributing the heavy rare earth element in the vicinity of the grain boundary, but the residual magnetic flux density of a whole magnet scarcely lowers because the usage is small. A rare earth element used in a rare earth magnet is a scarce resource, sites where ore is buried distribute unevenly, and hence a possible problem is resource security.

There is no case of growing a fluorine compound described in Non-Patent Literature 1 and evaluating the structure with a high degree of accuracy.

In view of the above situation, a magnet that can decrease the usage of a rare earth element to the utmost is needed.

The present invention focuses attention on a rare earth-iron-fluorine compound formed by inserting fluorine among iron atoms. That is, an object of the present invention is to intend to increase magnetization and lower the usage of a magnet by inserting fluorine into the lattice of rare earth and iron and further into the lattice of iron.

Another object of the present invention is to magnetically bond at least two phases of a rare earth-iron-fluorine compound and iron by using ferromagnetic bond of the rare earth-iron-fluorine compound to the iron; and insert the fluorine into the lattice of the iron. The volume of the iron expands by the intrusion of the fluorine and the lattice of the tetragon distorts.

The present invention makes it possible to increase magnetization and the magnetic moment of an iron atom; and resultantly increase a residual magnetic flux density.

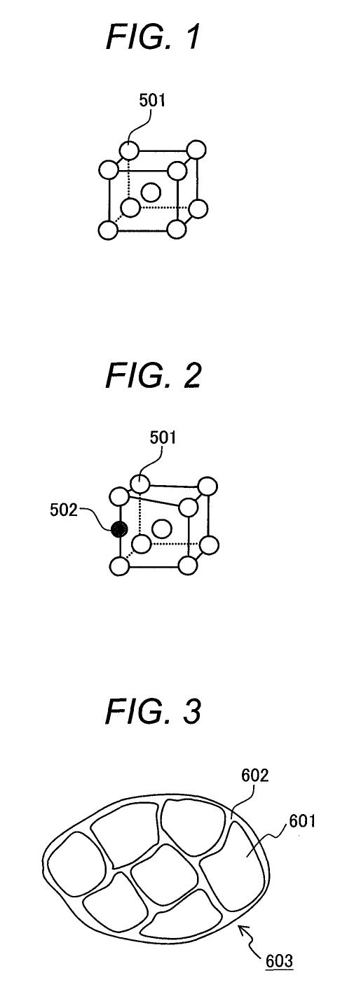

FIG. 1 is a pattern diagram showing a crystal structure (a body centered cubic crystal structure) of a conventional magnet.

The figure shows a bcc structure (a body centered cubic crystal structure) comprising iron atoms 501.

Further, FIG. 2 is a pattern diagram showing a crystal structure of a magnet according to an example of the present invention.

The figure shows the state where two iron atoms 501 bond to each other via a fluorine atom 502 and the crystal structure is distorted. That is, the crystal structure has a portion where adjacent iron atoms 501 bond directly to each other (called a homo portion) and a portion where two iron atoms 501 bond to each other via an atom other than an iron atom (a fluorine atom 502 in the figure) (called a hetero portion) and the distance between the two iron atoms 501 bonding via another atom is different from the distance between the adjacent iron atoms 501.

There are a plurality of methods for attaining the above objects.

In any of the methods, a fluorine compound solution not containing pulverized particles but having transparency is used.

Among the methods, a first method is a method of impregnating a fluorine compound solution into a low-density formed-body having interstices (voids or pores) and thereafter sintering the formed-body.

A second method is a method of mixing surface-treated magnetic particles formed by coating the surfaces of magnetic particles with a fluorine compound beforehand with untreated magnetic particles and thereafter preliminarily molding and sintering the mixture.

A third method is a method of locally dispersing a fluorine compound from the surface of a sintered block.

When a magnet is produced by growing a mixed phase of Sm₂Fe₁₇F₃ andiron (Fe) of a tetragon (a bct), the particle size distribution of magnetic particles having a composition deviated from the composition of Sm₂Fe₁₇ magnetic particles by 0.1% to 10% toward the side of Fe is adjusted and thereafter the magnetic particle mixture is preliminarily molded in a magnetic field. The preliminarily-formed-body has interstices among magnetic particles and hence it is possible to coat the preliminarily-formed-body up to the center portion thereof with a fluorine compound solution by impregnating the fluorine compound solution into the interstices.

Here, a preliminarily-formed-body means a substance being in the state of a low density before sintering.

On this occasion, a solution of a high transparency, a solution of a high transparency, or a solution of a low viscosity is desirable as the fluorine compound solution, and it is possible to permeate and coat the fine interstices of magnetic particles with the fluorine compound solution by using such a solution.

One of the conditions for dispersing fluorine up to the centers of magnetic particles is to reduce the surfaces of the magnetic particles by using hydrogen gas and lower an oxygen concentration before impregnation treatment. Rare earth oxide is reduced by the hydrogen treatment and oxide such as Mre₂O₃ (here, Mre represents a rare earth element) is removed beforehand. By removing oxide, it is possible to inhibit the growth of oxidized fluoride caused by reaction between a fluorine compound and the oxide; and increase the concentration of the fluorine intruding into the interstices among iron atoms. By the reduction treatment with the hydrogen gas, it is possible to increase the quantity of intruding fluorine and fluorine contained in fluoride in a mother phase more than the quantity of the fluorine constituting the oxidized fluoride finally formed in a magnet; and to improve magnetic properties.

The above impregnation can be carried out also by making a part of a preliminarily-formed-body contact to a fluorine compound solution, the plane of the preliminarily-formed-body touching the fluorine compound solution is coated with the fluorine compound solution, and as long as interstices of 1 nm to 1 mm are formed on the coated plane, the surfaces of the magnetic particles in the interstices are coated with the fluorine compound solution. The direction of the impregnation is the direction where the interstices (also called communicating holes) are continuously formed in the preliminarily-formed-body and depends on the conditions of the preliminary forming and the shape of the magnetic particles.

In the above impregnation, the coating weight differs between the outer surface of the preliminarily-formed-body directly touching the fluorine compound solution and the other outer surface not directly touching the fluorine compound solution and hence it is possible to give concentration difference to some of the elements constituting the fluorine compound after sintering. Further, it is possible to averagely give difference to the concentration distribution of the fluorine compound between the outer surface of the preliminarily-formed-body directly touching the fluorine compound solution and the inner face (the inner wall face of communicating holes) of the preliminarily-formed-body not directly touching the fluorine compound solution that is in the direction of the impregnation.

A fluorine compound solution is a solution containing a fluorine compound containing carbon having a structure similar to an amorphous structure or a fluorine oxygen compound (hereunder referred to as fluoric acid compound) partially containing oxygen, those compounds containing one or more kinds of alkali metal elements, alkali earth elements, and rare earth elements, and the impregnation treatment can be applied at room temperature. A solvent is removed by heat-treating a preliminarily-formed-body impregnated with the above solution at 200° C. to 400° C., and carbon, a rare earth element, and elements constituting a fluorine compound are dispersed into the interstices between the fluorine compound and the magnetic particles and into grain boundaries by heat-treating the preliminarily-formed-body at 500° C. to 800° C.

Another used processing liquid for forming a rare earth fluoride or alkali earth metal fluoride coating film can also be formed through a process nearly identical to the above process, and even when various kinds of elements are added to a fluorine system processing liquid containing a rare earth or alkali earth element such as Dy, Nd, La or Mg, the diffraction pattern of any of the solutions does not coincide with that of a fluorine compound or an oxidized fluorine compound represented by MeₙFₘ (Me represents a rare earth element or an alkali earth element and n and m represent positive numbers) or MeₙFₘOₚC_{q} (Me represents a rare earth element or an alkali earth element, O represents oxygen, C represents carbon, F represents fluorine, and n, m, p, and q represent positive numbers) or a compound with an added element. As the diffraction pattern of such a solution or a film formed by drying the solution, an X-ray diffraction pattern having plural peaks the half-value widths of which are one degree or more as the main peaks is observed. This shows that the interatomic distance between an added element and fluorine or between metal elements is different from MeₙFₘ and the crystal structure is also different from MeₙFₘ. Since the half-value widths are one degree or more, the interatomic distance is not a constant value but shows a certain distribution unlike an ordinary metallic crystal. The reason why the distance distributes is that other atoms are allocated around the atoms of the metal element or the fluorine element differently from the above compounds and the atoms are mostly hydrogen, carbon, and oxygen and the atoms of hydrogen, carbon and oxygen easily move, the structure changes, and the fluidity also changes by applying external energy such as heating. An X-ray diffraction pattern of a sol type or a gel type comprises a diffraction pattern containing a peak the half-value width of which is larger than one degree, but the structure changes by heat treatment and the diffraction pattern of MeₙFₘ, Meₙ (F, C, O)ₘ (the proportions of F, C, and O are optional), or Meₙ (F, O)ₘ (the proportions of F and O are optional) comes to be seen partially. The half-value width of such a diffraction peak is narrower than that of the diffraction peak of a sol or a gel. In order to enhance the fluidity of a solution and equalize a coated film thickness, it is important that at least one peak having a half-value width of one degree or more is seen in the diffraction pattern of the solution.

Oxygen of 10 to 1,000 ppm is contained in magnetic particles and light elements such as H, C, P, Si, and Al or transition metal elements are contained as other impurity elements. Oxygen contained in magnetic particles exists not only as rare earth oxide and oxide of light elements such as Si and Al but also as a phase containing oxygen having a composition deviating from a stoichiometric composition in a mother phase and at a grain boundary.

Such a phase containing oxygen decreases the magnetization of magnetic particles and influences the shape of a magnetization curve. That is, the phase leads to the decrease of a residual magnetic flux density, the decrease of anisotropy field, the deterioration of squareness in a demagnetization curve, the deterioration of a coercive force, the increase of an irreversible demagnetizing ratio, the increase of thermal demagnetization, the fluctuation of a magnetization characteristic, the deterioration of corrosion resistance, and the deterioration of mechanical properties and the reliability of a magnet lowers. Since oxygen influences many characteristics as stated above, a process to minimize oxygen in magnetic particles has been studied.

When Mre₂Fe₁₇ system magnetic particles (here, Mre represents a rare earth element) having an oxygen concentration of 1,000 ppm or more are used, fluorine bonds with oxygen during fluoride solution processing, oxidized fluoride grows, and fluorine atoms are hardly allocated at intrusion sites such as interstitial sites among iron atoms. Consequently, it is necessary to remove oxygen before processing in a fluoride solution and decrease oxygen to at least 100 ppm or lower.

A rare earth fluorine compound growing on the surfaces of magnetic particles by impregnating the above solution partially contains a solvent. Then Mre₂Fe₁₇F₃ and iron (Fe) having a bct structure (a body centered tetragonal structure) or a bcc structure (a body centered cubic crystal structure) are grown by heat treatment at 400° C. or lower and are heated to and retained at 400° C. to 900° C. in a vacuum of 1×10⁻³ Torr or lower. The retention time is 30 minutes.

By the heat treatment, iron atoms and a rare earth element in magnetic particles disperse into the fluorine compound, and Mre₂Fe₁₇F₃ and Fe of a bcc or bct structure grow. Since the solution is impregnated along interstices penetrating from the surface of a formed-body, a grain boundary phase containing fluorine is formed into a nearly continuous layer linking from the surface to another surface in a magnet after sintered. Here, a formed-body means a material that is sintered partially.

It is possible to grow a compound allocated at fluorine interstitial sites in a magnet and sinter the compound at relatively low temperatures of 200° C. to 1,000° C. by using the above processing liquid and the following effects are obtained by impregnating the above processing liquid.

1) It is possible to decrease the quantity of a fluorine compound necessary for processing, 2) it is possible to apply the method to a sintered magnet 10 mm or more in thickness, 3) it is possible to lower the temperature at which fluorine atoms intrude, and 4) it comes to be unnecessary to apply heat treatment for dispersion after sintering.

As a result of those effects, the effects of the increase of a residual magnetic flux density at an impregnated portion, the increase of a coercive force, the improvement of squareness in a demagnetization curve, the improvement of thermal demagnetization, the improvement of a magnetization characteristic, the improvement of anisotropy, the improvement of corrosion resistance, low loss, the improvement of mechanical properties, and the reduction of the production cost are obtained conspicuously in a heavy plate magnet.

When magnetic particles are a SmFe system, Sm, Fe, F, an added element or an impurity element diffuses into a fluorine compound at a hearting temperature of 200° C. or higher. At the temperature, the fluorine concentration in the fluorine compound layer varies by location, MreF₂, MreF₃, or a oxidized fluorine compound thereof is formed discontinuously in a laminar shape or in a tabular shape, but a nearly continuous fluorine compound is formed into a laminar shape in the impregnation direction, and a layer linking from a surface to the opposite surface is formed.

The driving force of the diffusion is temperature, stress (strain), concentration difference, defects, and others and the result of the diffusion can be observed with an electron microscope or the like. By impregnating and using a solution not using pulverized particles of a fluorine compound, the fluorine compound can already be formed in the center of a preliminarily-formed-body at room temperature and can be dispersed at a low temperature, hence the usage of the fluorine compound can be decreased, and in particular the effects are conspicuous at a high temperature in the case of SmFeF system magnetic particles that are hardly sintered. The SmFeF system magnetic particles contain magnetic particles formed by growing the phase of the crystal structure of Sm₂Fe₁₇F₃ and Fe having a bct or bcc structure in the main phase and may contain transition metals such as Al, Co, Cu, and Ti in the main phase. Further, a part of F may be replaced with C.

Further, oxidized fluoride (also called fluoroxide) may be contained other than the main phase. A sintered magnet formed through a process of impregnating such a fluorine compound contains either a layer in which fluorine exists continuously from a surface to another surface of the magnet or a laminar grain boundary containing fluorine not linked to a surface in the interior of the magnet.

At such an impregnated portion, a fluorine compound distributes unevenly in the vicinity of a grain boundary and a coercive force and a residual magnetic flux density increase. The coercive force increases to a value 1.1 to 3 times that of a not-impregnated portion in the case where a PrF system solution is used.

FIG. 3 is a schematic sectional view showing the structure of magnetic particles constituting a magnet according to an example of the present invention.

In the figure, a formed-body 603 (a magnet) is formed by compressively molding a plurality of magnetic particles 601. Then metal fluoride films 602 are formed at the voids of the formed-body 603. The metal fluoride films 602 are formed by impregnating a fluorine compound solution into the voids of the formed-body 603 and thereafter sintering the formed-body 603 at a high temperature.

At a portion where a coercive force increases, a residual magnetic flux density increases by 1% to 10% and only thermal resistance improves at the impregnated portion. Consequently, it is possible to enhance the coercive force and the residual magnetic flux density in the vicinity of a corner to which an opposing magnetic field is applied in a motor. The content of Fe is higher in the case of the Mre₂Fe₁₇ system than in the case of the Mre₂Fe₁₄B system and the higher Fe content leads to the improvement of resource security.

Further, with regard to a compound of MreₙFeₘ (m/n>7) having an Fe concentration higher than Mre₂Fe₁₇ too, it is possible to enhance the coercive force and the residual magnetic flux density.

Furthermore, the portions that require a high coercive force and a high residual magnetic flux density may be bilaterally asymmetrical to the polar center in the radial direction in a magnet motor. It is possible to decrease the usage of a rare earth element by using a method of impregnation or diffusion processing in order to form bilaterally asymmetrical portions having a high coercive force and a high residual magnetic flux density.

A magnet according to the present invention is characterized in that all or some of the atoms other than iron atoms are an element selected from the group consisting of fluorine, boron, carbon, nitrogen and oxygen, i.e. an atom other than iron is an element selected from the group consisting of fluorine, boron, carbon, nitrogen and oxygen. That is, the hetero portion contains an element selected from the group consisting of fluorine, boron, carbon, nitrogen and oxygen.

A magnet according to the present invention is characterized in that the magnetic particles contain a rare earth element.

A magnet according to the present invention is characterized in having a structure formed by touching a mother phase constituting a center portion of the magnetic particles directly to a crystal containing the hetero portion.

A magnet according to the present invention is characterized in that the metal fluoride film contains a fluoride of at least one element selected from the group consisting of rare earth elements, alkali metal elements and alkali earth metal elements.

A magnet according to the present invention is characterized in that the concentration of the atom other than iron contained in the mother phase is higher at an outer circumferential portion of the mother phase than at a center portion of the mother phase.

A rotor according to the present invention is characterized in that a magnet described above is used.

A rotor according to the present invention is characterized in that the concentration of the atom other than iron at an outer circumferential portion of the magnet is higher than that of the atom other than iron at an inner circumferential portion of the magnet.

A rotor according to the present invention is characterized in that the magnetic flux density at the outer circumferential portion of the magnet is higher than that at the inner circumferential portion of the magnet.

A rotor according to the present invention is characterized in that the magnetic flux density and the coercive force at the outer circumferential portion of the magnet are higher than those at the inner circumferential portion of the magnet.

A motor according to the present invention is characterized in that a magnet described above is used.

A motor according to the present invention is characterized in that a rotor described above is used.

A rotary electrical apparatus according to the present invention is characterized in that a magnet described above is used.

The present invention is hereunder explained in reference to examples.

### First Embodiment

A processing liquid for forming a (Pr_{0.9}Cu_{0.1}) Fₓ (x=1 to 3) rare earth fluoride coated film is prepared by the following procedure.

(1) Praseodymium nitrate of 4 g is put into water of 100 mL and completely dissolved with a shaker or an ultrasonic stirrer.

(2) Hydrofluoric acid diluted to 10% is added gradually by a quantity equivalent to chemical reaction for generating PrFₓ (x=1 to 3).

(3) The solution in which gelatinously deposited PrFₓ (x=1 to 3) is formed is stirred for one hour or longer with an ultrasonic stirrer.

(4) Centrifugal separation is applied to the solution at a rotation of 6,000 to 10,000 r.p.m. and thereafter the supernatant liquid is removed and methanol of a nearly identical quantity is added.

(5) The methanol solution containing gelatinous PrF clusters is stirred to a complete suspension and thereafter stirred for one hour or longer with an ultrasonic stirrer.

(6) The operations of the process steps (4) and (5) are repeated 3 to 10 times until negative ions such as acetate ions and nitrate ions are not detected.

(7) In the case of a PrF system, nearly transparent sol-like PrFₓ is obtained. The processing liquid is produced by adjusting the liquid so that a methanol solution having a PrF concentration of 1 g per 5 mL may be obtained.

(8) An organometallic compound of copper (Cu) (bisacetylacetone copper (II)) is added to the processing liquid under the condition of not changing the solution structure.

An X-ray diffraction pattern of the above processing liquid or a film formed by drying the above processing liquid is measured and the result is that the X-ray diffraction pattern comprises a plurality of peaks having half-value widths of 2 degrees or more (2 to 10 degrees). This shows that the interatomic distance between an added element and fluorine or between an added element and a metallic element is different from MreₙFₘ and the crystal structure thereof is also different from MreₙFₘ and Mreₙ (F, O)ₘ. Here, Mre represents a rare earth element, F represents fluorine, O represents oxygen, and n and m represent positive integers.

Meanwhile, a half-value width means the length of a segment obtained by drawing a line in parallel with a base line at the position half in the strength of the peak having the maximum strength. That is obtained from an X-ray diffraction pattern measured by θ-2θ scanning with a CuKα ray.

Since the half-value widths are 2 degrees or more, it is understood that the interatomic distance is not a constant value but shows a certain distribution unlike an ordinary metallic crystal.

The reason why such distribution is generated is that other atoms are allocated around the atoms of the metallic element or the fluorine element differently from the above compound and the atoms are mostly hydrogen, carbon, or oxygen. By adding external energy such as heating, the atoms of hydrogen, carbon, or oxygen move easily, the structure changes, and the fluidity also changes.

An X-ray diffraction pattern of a sol or a gel comprises peaks the half-value widths of which are larger than one degree but the structure changes by heat treatment and a part of the diffraction pattern of MreₙFₘ or Mreₙ (F, O)ₘ comes to be measured. Even when Cu is added, a long-period structure does not appear in the X-ray diffraction of the above processing liquid. Here, a long-period structure means a structure having a long period formed by overlaying unit cells of iron in any one of the three-dimensional directions.

The half-value width of the diffraction peak of MreₙFₘ is narrower than that of the diffraction peak of a sol or a gel. It is important that the diffraction pattern of the processing liquid has at least one peak having a half-value width of 2 degrees or more in order to enhance the fluidity of the processing liquid and equalize the coating film thickness. Such a peak having a half-value width of one degree or more and a peak of the diffraction pattern of MreₙFₘ or an oxidized fluorine compound may be included.

When only the diffraction pattern of MreₙFₘ or an oxidized fluorine compound or a diffraction pattern of one degree or less is mainly observed in the diffraction pattern of the above processing liquid, it is judged that a solid phase other than a sol or a gel is contained in the processing liquid. This coincides with the deterioration of fluidity.

Successively, Sm₂Fe_{17.2} particles are coated with the processing liquid.

(1) A preliminarily-formed-body (10×10×10 mm) of Sm₂Fe_{17.2} is produced by compression molding at room temperature.

(2) The preliminarily-formed-body is reduced for 1 to 5 hours at 100° C. to 800° C. in a hydrogen atmosphere and thereafter immersed into a PrF system coating film forming liquid, and methanol as the solvent is removed from the block under a decompressed pressure of 2 to 5 Torr.

(3) The operation of the process step (2) is repeated 1 to 5 times and thereafter heat treatment is applied for 0.5 to 5 hours in the temperature range of 400° C. to 1,100° C.

(4) A pulsed magnetic field of 30 kOe or more is applied in the anisotropic direction of the anisotropic magnet on which the surface coating film is formed at the process step (3).

A demagnetization curve is measured by interposing the magnetized formed-body between the magnetic poles of a DC M-H loop measuring device so that the magnetization direction may coincide with the direction of the application of a magnetic field; and applying the magnetic field between the magnetic poles. FeCo alloy is used for the pole pieces of the magnetic poles used for applying the magnetic field to the magnetized formed-body and the value of the magnetization is calibrated by using a pure Ni specimen and a pure Fe specimen of an identical shape.

As a result, the coercive force of the block of Sm₂Fe_{17.2} on which the Pr fluoride coating film (the praseodymium fluoride film) is formed is increased ten times to 1 kOe from the original value of 0.1 kOe.

Further, it is confirmed from X-ray diffraction or electron diffraction that two phases comprising Fe of a bcc or bct structure and Sm₂Fe_{17.2}F₃ are formed. It is further confirmed that Fe having a bcc or bct structure and having the lattice constants on the major axis of 0.28 to 0.32 nm grows adjacently to Sm₂Fe_{17.2}F₃ showing a high coercive force; and that both the phases are electrically connected to each other from the observation of the magnetic domain structure and the shape of the magnetization curve. A wide-angle X-ray diffractometer is used for measuring an X-ray diffraction pattern, Cu is used for the X-ray source, the X-ray output is 250 mA, and a concentrated beam with a monochromator is used for the optical system. The slit width is 0.5 degree.

From the analysis of the crystal structure, it is confirmed that some of the fluorine atoms intrude into some of the interstices among iron atoms and the major axis of the bct structure is 0.28 to 0.32 nm. Here, a site into which a fluorine atom intrudes is called an interstitial site.

With regard to the allocation of the fluorine atoms to interstitial sites, either that the diffraction angle of the X-ray diffraction peak shifts toward the side of the low angle or that a diffraction peak separates and coincides with the bct diffraction pattern is observed.

Further, the role of an added element such as Cu is any one of the following roles.

1) To be unevenly distributed in the vicinities of grain boundaries and lower interface energy. 2) To enhance the lattice matching of grain boundaries. 3) To decrease defects at grain boundaries. 4) To help fluorine atoms to diffuse into interstitial sites. 5) To increase magnetic anisotropy energy caused by fluorine atoms. 6) To smoothen an interface with fluoride, oxidized fluoride, or carbonated fluoride. 7) To enhance the thermal stability of fluorine atoms at interstitial sites. 8) To remove oxygen from a mother phase. 9) To raise the Curie temperature of a mother phase ((Sm, Pr)₂Fe₁₇F₃). 10) To segregate the added element including Cu in a grain boundary center and make a grain boundary phase nonmagnetic. 11) To strengthen bond at an interface between a mother phase and iron.

From the above roles, any of the effects of the increase of a coercive force, the improvement of squareness in a demagnetization curve, the increase of a residual magnetic flux density, the increase of an energy product, the rise of a Curie temperature, the decrease of magnetizing magnetic field, the decrease of the temperature dependency of a coercive force and a residual magnetic flux density, the improvement of corrosion resistance, the increase of a resistivity, and the decrease of a thermal demagnetizing factor is recognized.

An added element such as Cu is heated and diffused after processed with a solution and hence is likely to have a high concentration in the vicinities of grain boundaries where a rare earth element is unevenly distributed unlike the distribution of an element added to a sintered magnet beforehand. When a rotor is produced by binding a thus produced magnet having the (Sm, Pr)₂Fe₁₇F₃ structure as the main phase and being formed by growing iron of a bcc or bct structure to a laminated flat rolled magnetic steel sheet, a laminated amorphous material, or compressed particulate iron, the magnet is inserted into the insertion position beforehand.

Magnetic properties are not largely influenced at 20° C. as long as the Mre₂Fe₁₇F₃ structure stated above has defects at the sites of fluorine atoms or excessive fluorine is allocated at the interstitial sites and the composition is in the range of Mre₂Fe₁₇F₃₊₂. Further, the atoms of carbon, oxygen, nitrogen, or boron of a concentration within the range not changing a crystal structure may be contained in some of the sites of fluorine atoms.

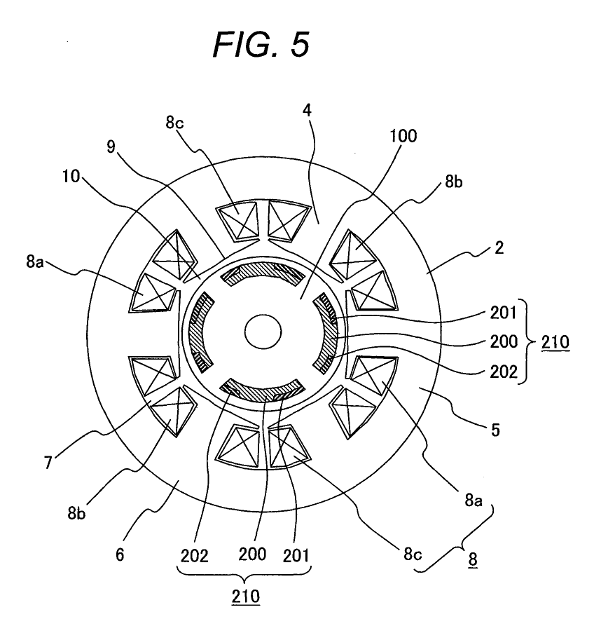

FIG. 5 is a schematic sectional view perpendicular to the motor axis showing a motor to which a magnet according to the present invention is applied.

A motor comprises a rotor 100 and a stator 2. The stator 2 contains a core back 5 and teeth 4 and a coil group comprising coils 8a, 8b, and 8c (three-phase wiring comprising U-phase wiring 8a, V-phase wiring 8b, and W-phase wiring 8c) is inserted at coil insertion positions 7 between adjacent teeth 4. A rotor insertion space 10 containing the rotor 100 is secured on the inside of teeth tips 9 (called a shaft center portion or a rotation center portion) and the rotor 100 is inserted into the space. Sintered magnets 210 are inserted on the outer circumferential side (the outer circumferential portion) of the rotor 100. Each of the sintered magnets 210 comprises a fluorine untreated portion 200 (a portion not treated with a fluoride solution) and fluorine treated portions 201 and 202 (portions treated with a fluoride solution).

The areas of the fluorine treated portions 201 and 202 in each of the sintered magnets 210 are different from each other and the fluorine treated portion of a higher magnetic field strength to which an opposing magnetic field is applied in magnetic field design is subjected to fluoride treatment over a wider area and thus the coercive force and the residual magnetic flux density are enhanced.

By applying fluoride treatment partially to the outer circumferential sides (the outer circumferential portions) of the sintered magnets 210 as stated above, it is possible to decrease the usage of a rare earth element, improve proof demagnetization, expand the applicable temperature range, and increase a motor output. Here, the outer circumferential side (the outer circumferential portion) of a sintered magnet 210 means the portion of the sintered magnet 210 located on the outer circumferential side of a rotor 100 as viewed from the center of the rotor 100 in the state of installing the sintered magnet 210 in the rotor 100. Meanwhile, the inner circumferential side (the inner circumferential portion) of a sintered magnet 210 means the portion of the sintered magnet 210 located on the center portion side of a rotor 100 as viewed from the center of the rotor 100 in the state of installing the sintered magnet 210 in the rotor 100.

In the figure, the concentration of fluorine atoms at the outer circumferential portion of a sintered magnet 210 is higher than the concentration of fluorine atoms at the inner circumferential portion of the sintered magnet 210.

The configuration of a sintered magnet 210 is not limited to the configuration shown in FIG. 5 and the allocation of the fluorine untreated portion 200 and fluorine treated portions 201 and 202 can arbitrarily be selected. By so doing, it is possible to easily produce a sintered magnet 210 having the allocation of the fluorine untreated portion 200 and the fluorine treated portions 201 and 202 suitable for the rotor 100 of a motor. The allocation can be adjusted by setting the portion and the time for impregnating a fluorine compound solution into a preliminarily-formed-body when fluoride treatment is applied after the preliminarily-formed-body of the magnet is produced.

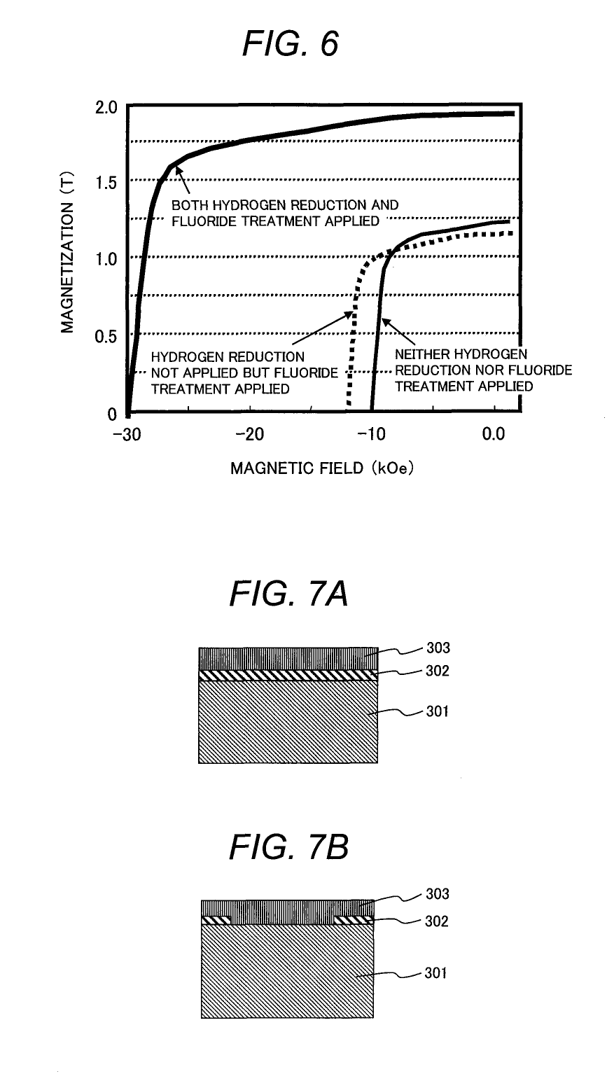

FIG. 6 is a graph (of the second quadrant of a magnetic hysteresis loop) showing the relationship between a magnetization and a magnetic field in a magnet according to an example of the present invention.

In the figure, the present example in which both reduction treatment by hydrogen and fluoride treatment are applied is shown with the solid line, the comparative example in which both reduction treatment by hydrogen and fluoride treatment are not applied is shown with an alternate long and short dash line, and the other comparative example in which reduction treatment by hydrogen is not applied but fluoride treatment is applied is shown with a dotted line.

It is obvious from the figure that both the coercive force and the residual magnetic flux density are larger in the present example than in the comparative examples.

### Second Embodiment

A processing liquid for forming an SmFₓ (x=1 to 3) rare earth fluoride coated film is prepared by the following procedure.

(1) Samarium nitrate of 4 g is put into water of 100 mL and completely dissolved with a shaker or an ultrasonic stirrer.

(2) Hydrofluoric acid diluted to 10% is added gradually by a quantity equivalent to chemical reaction for generating SmFₓ (x=1 to 3).

(3) The solution in which gelatinously deposited SmFₓ (x=1 to 3) is formed is stirred for one hour or longer with an ultrasonic stirrer.

(4) Centrifugal separation is applied to the solution at a rotation of 6,000 to 10,000 r.p.m. and thereafter the supernatant liquid is removed and methanol of a nearly identical quantity is added.

(5) The methanol solution containing gelatinous SmF clusters is stirred to a complete suspension and thereafter stirred for one hour or longer with an ultrasonic stirrer.

(6) The operations of the process steps (4) and (5) are repeated 3 to 10 times until negative ions such as acetate ions and nitrate ions are not detected.

(7) In the case of an SmF system, nearly transparent sol-like SmFₓ is obtained. The processing liquid is produced by adjusting the liquid so that a methanol solution having a SmFₓ concentration of 1 g per 5 mL may be obtained.

(8) An organometallic compound of copper (Cu) (bisacetylacetone copper (II)) is added to the processing liquid under the condition of not changing the solution structure.

An X-ray diffraction pattern of the above processing liquid or a film formed by drying the above processing liquid is measured and the result is that the X-ray diffraction pattern comprises a plurality of peaks having half-value widths of one degree or more (2 to 10 degrees). This shows that the interatomic distance between an added element and fluorine or between an added element and a metallic element is different from MeₙFₘ and the crystal structure thereof is also different from MeₙFₘ and Meₙ (F, O, C)ₘ. Here, Me represents a rare earth element, an alkali metal, or an alkali earth element, F represents fluorine, O represents oxygen, C represents carbon, and n and m represent positive integers.

The proportions of fluorine, oxygen, and carbon vary from a product to another product and the proportions of fluorine and oxygen are larger than the proportion of carbon on the outermost surface of a sintered magnet. Since the half-value widths are one degree or more, it is understood that the interatomic distance is not a constant value but shows a certain distribution unlike an ordinary metallic crystal.

The reason why such distribution is generated is that other atoms are allocated around the atoms of the metallic element or the fluorine element differently from the above compound and the atoms are mostly hydrogen, carbon, and oxygen. By adding external energy such as heating, the atoms of hydrogen, carbon, or oxygen move easily, the structure changes, and the fluidity also changes.

An X-ray diffraction pattern of a sol or a gel comprises peaks the half-value widths of which are larger than one degree but the structure changes by heat treatment and a part of the diffraction pattern of MeₙFₘ or Meₙ (F, O, C)ₘ comes to be measured. Even when Cu is added, a long-period structure does not appear in the X-ray diffraction of the above processing liquid.

The half-value width of the diffraction peak of MeₙFₘ is narrower than that of the diffraction peak of a sol or a gel. It is important that the diffraction pattern of the processing liquid has at least one peak having a half-value width of one degree or more in order to enhance the fluidity of the processing liquid and equalize the coating film thickness. Such a peak having a half-value width of one degree or more and a peak of the diffraction pattern of MeₙFₘ or an oxidized fluorine compound may be included.

When only the diffraction pattern of MeₙFₘ or an oxidized fluorine compound or a diffraction pattern of one degree or less is mainly observed in the diffraction pattern of the above processing liquid, it is judged that a solid phase other than a sol or a gel is contained in the processing liquid. This coincides with the deterioration of fluidity.

Successively, Sm₂Fe_{17.1}N₃ is coated with the processing liquid.

(1) A formed-body (10×10×10 mm) of Sm₂Fe_{17.1}N₃ is produced by compression molding at room temperature.

(2) The oxygen concentration on the surfaces of the magnetic particles is decreased in a hydrogen gas atmosphere (300° C.), thereafter the formed-body is immersed into an SmF (samarium fluoride) system coating film forming liquid, and methanol as the solvent is removed from the block under a decompressed pressure of 2 to 5 Torr.

(3) The operation of the process step (2) is repeated 1 to 5 times and thereafter heat treatment is applied for 0.5 to 5 hours in the temperature range of 400° C. to 600° C.

(4) A pulsed magnetic field of 30 kOe or more is applied in the anisotropic direction of the anisotropic magnet on which the surface coating film is formed at the process step (3).

A demagnetization curve is measured by interposing the magnetized formed-body between the magnetic poles of a DC M-H loop measuring device so that the magnetization direction may coincide with the direction of the application of a magnetic field; and applying the magnetic field between the magnetic poles. FeCo alloy is used for the pole pieces of the magnetic poles used for applying the magnetic field to the magnetized formed-body and the value of the magnetization is calibrated by using a pure Ni specimen and a pure Fe specimen of an identical shape.

As a result, the coercive force of the block of the SmFeN formed-body on which the samarium fluoride coating film (the samarium fluoride film) is formed is increased double to 1.6 kOe from the original value of 0.8 kOe. Then the residual magnetic flux density increases by 10%.

It is confirmed by the measurement of an X-ray diffraction pattern that, in a magnet having a high coercive force, fluorine atoms are allocated at interstitial sites between iron atoms, an iron-fluorine phase of a bct (a body centered tetragon) structure grows, and the lattice constant of the major axis is 0.29 to 0.31 nm in average. Since the oxygen concentration is lowered by the reduction treatment, oxidized fluoride in a magnet is inhibited from growing. When the oxidized fluoride grows at the interfaces and the grain boundaries of the magnet particles, iron of a bcc or bct structure is likely to grow outside the oxidized fluoride, ferromagnetic bond between the main phase and iron weakens, and a residual magnetic flux density lowers. Here, a site into which a fluorine atom intrudes is called an interstitial site.

Nitrogen, besides fluorine atoms, also intrudes into the interstitial sites and it is estimated that magnetic anisotropy increases by the allocation of fluorine atoms at the interstitial sites and as a result a coercive force increases. Further, iron growing in a formed-body accounts for about 5% of the total volume and it is confirmed that fluorine intrudes into a part of the iron and thus a unit lattice volume expands or a tetragon grows. The axial ratio of the a-axis to the c-axis of a tetragon is 1.01 to 1.20 and lattice expansion is confirmed even when the concentration of fluorine is 14 to 18 atomic % in excess of the stoichiometric composition. It can be estimated that the magnetic moment of iron increases, ferromagnetic bond is generated at the interface between the iron of lattice expansion and the mother phase Sm₂Fe_{17.1}(N, F)₃ and a residual magnetic flux density increases by the lattice expansion.

Meanwhile, such effects are confirmed when the volume of iron is 0.1% to 20% of the total volume of a formed-body. The increase of a residual magnetic flux density is less than 10% when the volume of iron is less than 0.1% of the total volume of a formed-body and a coercive force tends to decrease from the maximum value when the volume of iron is larger than 20% of the total volume of a formed-body.

### Third Embodiment

Sm₂Fe_{17.1} magnetic particles 10 to 500 nm in grain size are reduced in a hydrogen atmosphere while being stirred, thus the oxygen concentration in the vicinities of the magnetic particle surfaces is decreased, and hydrogen of 10 to 100 ppm remains in the magnetic particles. The oxygen concentration after the reduction is 500 ppm. The surfaces of the magnetic particles are coated with an alcohol swelling solution of PrFₓ (x=1 to 5). The coating film thickness is 1 to 100 nm.

After the coating, the alcohol is removed by drying and the fluoride and the magnetic particles are reacted with each other. The reaction temperature is 350° C. or higher and here the condition of 900° C. and one hour is adopted although the optimum temperature depends on an alloy composition, a grain size, an oxygen concentration, and other conditions. The fluorination of the magnetic particles proceeds due to remaining hydrogen and fluorine atoms are allocated at interstitial sites among iron atoms by the rapid cooling during heat treatment.

The magnetic particles are molded at a load of 1 t/cm² in a magnetic field of 10 kOe and a preliminarily-formed-body of 100×100×200 mm is obtained. The preliminarily-formed-body is impregnated with a PrF₃ (praseodymium fluoride) solution containing Al by 1 atomic %, dried, and thereafter sintered at 600° C. After the sintering, the formed-body is magnetized in a magnetic field of 20 kOe or higher and magnetic properties are obtained from the measurement of a DC magnetization curve.

As the results of the magnetic properties, a residual magnetic flux density of 1.9 T and a coercive force of 25 kOe are confirmed. The residual magnetic flux density tends to increase as the lattice volume expansion of iron increases and the volume fraction of the iron after the lattice volume expansion increases. This is related to the fact that fluorine atoms intrude among iron atoms, expand the lattice of the iron, and increase the magnetic moment of the iron atoms. It is confirmed that the Curie temperature rises by 400° C. from 120° C. of untreated magnetic particles to 520° C. This example corresponds to No. 7 in Table 1.

The composition of the main phase of a formed-body produced by changing the composition of magnetic particles and applying fluorination similarly to the above method, the lattice volume expansion coefficient of iron growing as a structure other than the main phase, the volume fraction of iron showing lattice expansion in a whole magnet, the residual magnetic flux density of a formed-body, the coercive force of a formed-body, and the Curie temperature of a formed-body are shown in Table 1. In addition to Mre₂F₁₇ system magnetic particles, magnetic particles of an MreFe₁₁ system and an MreF₁₂ system can also be fluorinated and the Curie temperature is 330° C. or higher in those cases.

| | | Iron lattice | Volume fraction | Remanent | | Curie |
|---|---|---|---|---|---|---|
| | | volume expansion | of lattice | magnetic flux | Coercive | temperature |
| No. | Composition | coefficient (%) | expanded iron (%) | density (T) | force (kOe) | (° C.) |
| 1 | Sm₂Fe_{17.1}F₃ | 1 | 2 | 1.5 | 25 | 520 |
| 2 | Sm₂Fe_{17.1}F₃ | 5 | 2 | 1.6 | 25 | 525 |
| 3 | Sm₂Fe_{17.1}F₃ | 10 | 2 | 1.7 | 25 | 530 |
| 4 | (Sm_{0.9}Pr_{0.1})₂Fe_{17.2}F₃ | 1 | 3 | 1.4 | 24 | 515 |
| 5 | (Sm_{0.9}Pr_{0.1})₂Fe_{17.2}F₃ | 5 | 3 | 1.5 | 24 | 517 |
| 6 | (Sm_{0.9}Pr_{0.1})₂Fe_{17.2}F₃ | 10 | 3 | 1.6 | 26 | 525 |
| 7 | (Sm_{0.9}Pr_{0.2})₂Fe_{17.2}F₃ | 15 | 10 | 1.9 | 24 | 520 |
| 8 | La₂Fe_{17.1}F₃ | 10 | 10 | 1.8 | 24 | 530 |
| 9 | Y₂Fe_{17.1}F₃ | 10 | 9 | 1.7 | 25 | 510 |
| 10 | Ce₂Fe_{17.1}F₃ | 5 | 10 | 1.8 | 25 | 510 |
| 11 | Pr₂Fe_{17.1}F₃ | 5 | 10 | 1.8 | 24 | 510 |
| 12 | Gd₂Fe_{17.1}F₃ | 10 | 8 | 1.8 | 26 | 520 |
| 13 | Nd₂Fe_{17.1}F₃ | 10 | 10 | 1.8 | 20 | 530 |
| 14 | YFe₁₁F | 10 | 11 | 1.9 | 18 | 520 |
| 15 | NdFe₁₁F | 11 | 12 | 2.0 | 17 | 380 |
| 16 | SmFe₁₁F | 12 | 11 | 2.0 | 17 | 350 |
| 17 | SmFe₁₁F₂ | 12 | 12 | 2.0 | 16 | 340 |
| 18 | SmFe₁₂F | 11 | 12 | 2.0 | 18 | 330 |

A formed magnet fluorinated as stated above is an R—Fe—F system (R represents a rare earth element) magnet; is obtained by reacting a G component (G represents one or more kinds of elements selected from each of transition metal elements and rare earth elements or one or more kinds of elements selected from each of transition metal elements and alkali earth metal elements) and fluorine atoms; and is expressed by the following chemical formula (3) or (4);

RₐG_{b}T_{c}A_{d}FₑO_{f}M_{g} (3),

(R·G)_{a+b}T_{c}A_{d}FₑO_{f}M_{g} (4)

(Here, R represents one or more kinds selected from rare earth elements, M represents elements of 3 to 116 in atomic number except rare earth elements existing in a magnet before coated with a solution containing fluorine, G represents one or more kinds of elements selected from each of transition metal elements and rare earth elements or one or more kinds of elements selected from each of transition metal elements and alkali earth metal elements, R and G may be an identical element and the composition is expressed by the chemical formula (3) when R and G are not an identical element, and the composition is expressed by the chemical formula (4) when R and E are an identical element. T represents one or two kinds selected from Fe and Co, A represents one or two kinds selected from H (hydrogen) and C (carbon), a to g represent atomic percent of the alloy and a and b are in the ranges of 0.5≦a≦10 and 0.005≦b≦1 in the case of the chemical formula (3) and in the ranges of 0.6≦a+b≦11 in the case of the chemical formula (4), and then 0.01≦d≦1, 1≦e≦3, 0.01≦f≦1, 0.01≦g≦1, and remainder consists of c.)

It is found from X-ray diffraction, transmission electron diffraction with an electron microscope, an electron beam back-scattering pattern, measurement of a Mossbauer effect, neutron diffraction, and others that fluorine as a constituent element distributes so that the concentration may averagely increase from the center of a crystal grain constituting a magnet toward the surface thereof; and the volume fraction of an Fe—F phase mainly comprising Fe is smaller than that of the main phase containing a lot of a rare earth element in the magnet.

### Fourth Embodiment

SmFe₁₂ (samarium iron) magnetic particles 500 to 1,000 nm in grain size are reduced in an ammonia atmosphere while being stirred, thus the oxygen concentration in the vicinities of the magnetic particle surfaces is decreased, and hydrogen and nitrogen of 10 to 200 ppm remain in the magnetic particles. The oxygen concentration after the reduction is 600 ppm. The surfaces of the magnetic particles are coated with an alcohol swelling solution of SmFₓ (samarium fluoride, x=1 to 5). The coating film thickness is 10 nm. After the coating, the alcohol is removed by drying and thereafter the fluoride and the magnetic particles are reacted with each other. The reaction temperature is 350° C. or higher and here the condition of 900° C. and one hour is adopted although the optimum temperature depends on an alloy composition, a grain size, an oxygen concentration, and other conditions.

The fluorination of the magnetic particles proceeds due to remaining hydrogen and nitrogen, and fluorine atoms are allocated at interstitial sites among iron atoms by the rapid cooling during heat treatment. Some of the fluorine atoms displace hydrogen atoms and nitrogen atoms.

The magnetic particles are molded at a load of 1 t/cm² in a magnetic field of 10 kOe and a preliminarily-formed-body of 100×100×200 mm is obtained. The preliminarily-formed-body is impregnated with a SmF₃ solution containing Mg (magnesium) by 1 atomic %, dried, and thereafter sintered at 600° C. After the sintering, the formed-body is magnetized in a magnetic field of 20 kOe or higher and magnetic properties are obtained from the measurement of a DC magnetization curve. As the results of the magnetic properties, a residual magnetic flux density of 1.9 T and a coercive force of 25 kOe are confirmed.

The residual magnetic flux density tends to increase as the lattice volume expansion of iron increases and the volume fraction of the iron after the lattice volume expansion increases. This is related to the fact that nitrogen atoms and fluorine atoms intrude among iron atoms, expand the lattice of the iron, and increase the magnetic moment of the iron atoms. It is confirmed that the Curie temperature of the formed-body rises by 390° C. from 120° C. of untreated magnetic particles to 510° C. This example corresponds to No. 5 in Table 2.

The composition of the main phase of a formed-body produced by changing the composition of magnetic particles and applying fluorination similarly to the above method, the lattice volume expansion coefficient of iron in which a body centered tetragon having a structure other than the main phase grows, the volume fraction of iron showing lattice expansion in a whole magnet, the residual magnetic flux density of a formed-body, the coercive force of a formed-body, and the Curie temperature of a formed-body are shown in Table 2. In addition to Mre₂F₁₇ system magnetic particles, magnetic particles of an MreFe₁₁ system and an MreFe₁₂ system can also be fluorinated and the Curie temperature is 330° C. or higher in those cases.

TABLE 2

| | | Iron lattice | Volume fraction | Remanent | | Curie |
|---|---|---|---|---|---|---|
| | | volume expansion | of lattice | magnetic flux | Coercive | temperature |
| No. | Composition | coefficient (%) | expanded iron (%) | density (T) | force (kOe) | (° C.) |
| 1 | Sm₂Fe_{17.1}(F_{0.9},N_{0.1})₃ | 2 | 5 | 1.6 | 27 | 510 |
| 2 | Sm₂Fe_{17.1}(F_{0.8},N_{0.1})₃ | 4 | 6 | 1.5 | 28 | 515 |
| 3 | Sm₂Fe_{17.1}(F_{0.6},N_{0.1})₃ | 8 | 5 | 1.3 | 27 | 510 |
| 4 | Sm₂Fe_{17.1}(F_{0.4},N_{0.1})₃ | 8 | 10 | 1.6 | 29 | 505 |
| 5 | Sm₂Fe₁₂(F_{0.9},N_{0.1})₃ | 5 | 11 | 1.6 | 29 | 510 |
| 6 | La₂Fe_{17.1}(F_{0.9},N_{0.1})₃ | 8 | 10 | 1.7 | 28 | 510 |
| 7 | Y₂Fe_{17.1}(F_{0.9},N_{0.1})₃ | 5 | 13 | 1.9 | 25 | 500 |
| 8 | Ce₂Fe_{17.1}(F_{0.9},N_{0.1})₃ | 5 | 7 | 1.8 | 24 | 495 |
| 9 | Nd₂Fe_{17.1}(F_{0.9},N_{0.1})₃ | 5 | 5 | 1.7 | 26 | 480 |
| 10 | La₂Fe_{17.1}(F_{0.9},N_{0.1})₃ | 4 | 3 | 1.7 | 28 | 495 |
| 11 | YFe₁₁(F_{0.9},N_{0.1})₃ | 5 | 4 | 1.7 | 29 | 470 |
| 12 | CeFe₁₂(F_{0.9},N_{0.1})₃ | 5 | 1 | 1.5 | 26 | 480 |
| 13 | NdFe₁₃(F_{0.9},N_{0.1})₃ | 4 | 5 | 1.6 | 24 | 460 |
| 14 | LaFe₁₃(F_{0.9},N_{0.1})₃ | 3 | 6 | 1.5 | 27 | 480 |
| 15 | YFe₁₂(F_{0.9},N_{0.1})₃ | 5 | 9 | 1.6 | 26 | 490 |
| 16 | CeFe₁₂(F_{0.9},N_{0.1})₃ | 5 | 7 | 1.8 | 25 | 470 |
| 17 | Nd₂Fe_{17.1}(F_{0.9},N_{0.1})₃ | 3 | 5 | 1.6 | 23 | 486 |
| 18 | Sm₂(Fe,Co)_{17.1}(F_{0.9},N_{0.1})₃ | 4 | 2 | 1.6 | 24 | 410 |
| 19 | Sm₂(Fe,Co)_{17.1}(F_{0.9},N_{0.1})₃ | 5 | 1 | 1.5 | 23 | 405 |

A formed magnet fluorinated as stated above is an R—Fe—N—F system (R represents a rare earth element) magnet; is obtained by reacting a G component (G represents one or more kinds of elements selected from each of transition metal elements and rare earth elements or one or more kinds of elements selected from each of transition metal elements and alkali earth metal elements) and fluorine atoms and nitrogen atoms; and has a composition expressed by the following chemical formula (5) or (6);

RₐG_{b}T_{c}A_{d}(F,N)ₑO_{f}M_{g} (5),

(R·G)_{a+b}T_{c}A_{d}(F,N)ₑO_{f}M_{g} (6).

(Here, R represents one or more kinds selected from rare earth elements, M represents elements of 3 to 116 in atomic number except rare earth elements existing in a magnet before coated with a solution containing fluorine, G represents one or more kinds of elements selected from each of transition metal elements and rare earth elements or one or more kinds of elements selected from each of transition metal elements and alkali earth metal elements, R and G may contain an identical element and the composition is expressed by the chemical formula (5) when R and G do not contain an identical element, and the composition is expressed by the chemical formula (6) when R and G contain an identical element. T represents one or two kinds selected from Fe and Co, A represents one or two kinds selected from H (hydrogen) and C (carbon), a to g represent atomic percent of the alloy and a and b are in the ranges of 0.5≦a≦10 and 0.005≦b≦1 in the case of the chemical formula (5) and in the ranges of 0.6≦a+b≦11 in the case of the chemical formula (6), and then 0.01≦d≦1, 1≦e≦3, 0.01≦f≦1, 0.01≦g≦1, and remainder consists of c.)

It is found from X-ray diffraction, transmission electron diffraction with an electron microscope, an electron beam back-scattering pattern, measurement of a Mossbauer effect, neutron diffraction, and others that fluorine and nitrogen as constituent elements distribute so that the concentration may averagely increase from the center of a crystal grain constituting a magnet toward the surface thereof; and the volume fraction of an Fe—(F, N) phase mainly comprising Fe is smaller than that of the main phase containing a lot of a rare earth element in the magnet.

### Fifth Embodiment

Sm₂Fe₁₇N₂₋₃ magnetic particles 1,000 to 50,000 nm in grain size are reduced at 100° C. in a hydrogen atmosphere while being stirred, thus the oxygen concentration in the vicinities of the magnetic particle surfaces is decreased, and hydrogen of 100 ppm remains in the magnetic particles. The oxygen concentration after the reduction is 500 ppm. The surfaces of the magnetic particles are coated with an alcohol swelling solution of SmF₃. The coating film thickness is 10 nm. After the coating, the alcohol is removed by drying and thereafter the fluoride and the magnetic particles are reacted with each other. The reaction temperature is 400° C. and the reaction time is set at 100 hours although the optimum reaction time depends on an alloy composition, a grain size, an oxygen concentration, and other conditions.

The fluorination of the magnetic particles proceeds due to remaining hydrogen, and fluorine atoms are allocated at interstitial sites among iron atoms by rapid cooling during heat treatment. Some of the fluorine atoms displace intruding nitrogen atoms. From the evaluation results of X-ray diffraction, electron diffraction, neutron diffraction, and Mossbauer spectrometry, it is clarified that the positions of atoms most adjacent to fluorine atoms are occupied by iron atoms. A part of the iron lattice expands due to intruding fluorine atoms and changes the crystal structure from a body centered cubic crystal to a tetragon.

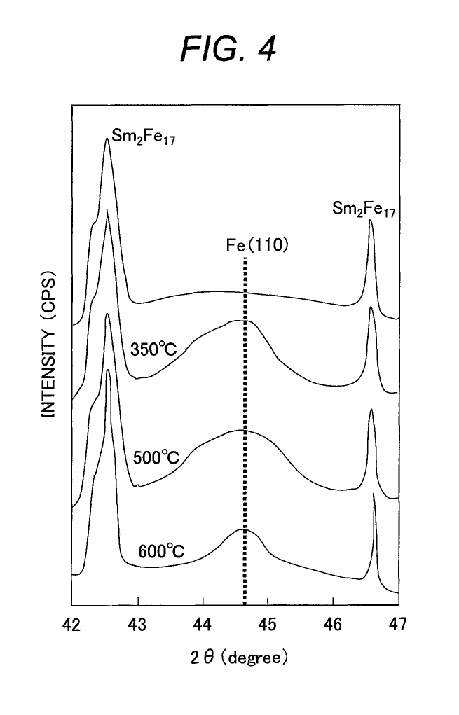

FIG. 4 is a graph showing X-ray diffraction patterns of a magnet according to an example of the present invention.

Besides the diffraction peak of an Sm₂Fe₁₇ system formed by the intrusion of nitrogen and fluorine atoms, a diffraction peak of iron having a wide diffraction width is observed in each of the cases of magnetic particles after heat-treated at the heat treatment temperatures of 350° C., 500° C. and 600° C.

The heat treatment is applied after the reaction with fluoride (a reaction temperature of 400° C.). The diffraction peak of iron shifts toward the low angle side as the heat treatment temperature lowers and fluorine atoms are allocated at tetrahedral sites or octahedral sites that are the interstices of a body centered cubic crystal as the basic lattice of Fe. It shows that the crystal lattice of Fe expands. The magnetic particles are molded at a load of 1 t/cm² in a magnetic field of 10 kOe and a preliminarily-formed-body of 100×100×500 mm is obtained.

The preliminarily-formed-body is impregnated with an SmF₃ solution containing Cu by 1 atomic %, dried, and thereafter sintered at 600° C. After sintered, the formed-body is magnetized at a magnetic field of 20 kOe or more and magnetic properties are obtained from the measurement of a DC magnetization curve. As the results of the magnetic properties, it is confirmed that the residual magnetic flux density is 1.9 T and the coercive force is 30 kOe. The residual magnetic flux density tends to increase as the lattice volume expansion of iron increases and the volume fraction of the iron after the lattice volume expansion increases. This is related to the fact that fluorine atoms intrude among iron atoms, expand the lattice of the iron, and increase the magnetic moment of the iron atoms.

It is confirmed that the Curie temperature rises by 50° C. from 480° C. of untreated magnetic particles to 530° C. Further, the resistivity of the magnet increases by 10% to 50% by the intrusion of fluorine.

As fluorine compounds that have the effects of allocating fluorine atoms at interstitial sites among iron atoms and expanding the crystal lattice of the iron as stated above, besides DyF₃ of the DyF system, named are fluorine compounds such as LiF, MgF₂, CaF₂, ScF₃, VF₂, VF₃, CrF₂, CrF₃, MnF₂, MnF₃, FeF₂, FeF₃, CoF₂, CoF₃, NiF₂, ZnF₂, AlF₃, GaF₃, SrF₂, YF₃, ZrF₃, NbF₅, AgF, InF₃, SnF₂, SnF₄, BaF₂, LaF₂, LaF₃, CeF₂, CeF₃, PrF₂, PrF₃, NdF₂, SmF₂, SmF₃, EuF₂, EuF₃, GdF₃, TbF₃, TbF₄, DyF₂, NdF₃, HoF₂, HoF₃, ErF₂, ErF₃, TmF₂, TmF₃, YbF₃, YbF₂, LuF₂, LuF₃, PbF₂, and BiF₃; and a solution of a compound formed by containing oxygen, carbon, or a transition metal element in such a fluorine compound. It is desirable to use such a solution by removing moisture in a solvent and increasing the fluorine concentration so that the oxygen concentration may be 1,000 ppm or lower in the solution in order to enhance reactivity.

When a rotor is manufactured by bonding a magnet that is produced by the above production method, has a bcc or bct structure in which fluorine atoms are allocated at interstitial sites, and is a mixed phase including an Fe—F three-elements system containing a third element as the main phase to a laminated flat rolled magnetic steel sheet, a laminated amorphous material, or compressed particulate iron, the magnet is inserted into the insertion position beforehand.

FIG. 5 is a schematic sectional view showing a magnet motor to which a magnet according to an example of the present invention is applied.

A motor comprises a rotor 100 and a stator 2. The stator 2 contains a core back 5 and teeth 4 and a coil group of a coil 8 (including three-phase wiring comprising U-phase wiring 8a, V-phase wiring 8b, and W-phase wiring 8c) is inserted at coil insertion positions 7 between adjacent teeth 4. A rotor insertion space 10 containing the rotor 100 is secured on the inside of teeth tips 9 (called a shaft center portion or a rotation center portion) and the rotor 100 is inserted into the space. Sintered magnets 210 are inserted on the outer circumferential side of the rotor 100. Each of the sintered magnets 210 comprises a fluorine untreated portion 200 (a portion not treated with a fluoride solution) and fluorine treated portions 201 and 202 (portions treated with a fluoride solution).

The areas of the fluorine treated portions 201 and 202 in each of the sintered magnets 210 are different from each other and the fluorine treated portion of a higher magnetic field strength to which an opposing magnetic field is applied in magnetic field design is subjected to fluoride treatment over a wider area and thus the coercive force and the residual magnetic flux density are enhanced.

By applying fluoride treatment partially to the outer circumferential sides of the sintered magnets 210 as stated above, it is possible to decrease the usage of a rare earth element, improve proof demagnetization, expand the applicable temperature range, and increase a motor output.

### Sixth Embodiment

In the present example, Nd₂Fe₁₄B particles 0.5 to 10 μm in grain size are inserted into a metal mold installed in a molding apparatus to which a magnetic field can be applied.

A film containing fluoride is grown on the magnetic particle surfaces by using a solution containing Nd fluoride (neodymium fluoride) before the insertion. The average film thickness is 0.1 to 2 nm. In the film containing fluoride, oxidized fluoride of amorphia or rhombohedral crystal and fluoride of crystalloid grow and the structure changes by heat treatment for removing a solvent. Oxidized fluoride containing Nd grows in the film by heating and drying in the air. It is confirmed that the crystal structure of the heated and dried oxidized fluoride changes from a rhombohedral crystal to a cubic crystal due to temperature rise and the structure change is recognized by the measurement of an X-ray diffraction pattern in the temperature range of 500° C. to 700° C.

Magnetic particles on the surfaces of which fluoride accompanying such structure change is formed are inserted into a magnetic particle inserting portion and a magnetic field of 5 kOe or more is applied. A preliminarily-formed-body is produced by applying a load of 1 to 3 t/cm² during the application of the magnetic field. The preliminarily-formed-body is heated and sintered in a vacuum. The sintering temperature is 1,050° C. and a liquid phase is formed in the preliminarily-formed-body and sintered. After the sintering, the formed-body is heated again to 550° C. and thereafter cooled rapidly.

Before aging treatment, a part of fluoride reacts with oxygen contained in the magnetic particles and turns into oxidized fluoride. Consequently, the crystal structure of oxidized fluoride before aging contains a crystal structure other than a cubic crystal. With regard to an aging temperature in the final heat treatment, in order to form cubic crystal more than rhombohedral crystal, the formed-body is heated to and retained at a temperature on the side higher than the temperature at which oxidized fluoride transforms from rhombohedral crystal to cubic crystal and thereafter cooled. By the aging heat treatment, the cubic crystal stable on the high temperature side is maintained up to room temperature and hence the crystal structure of oxidized fluoride in the vicinities of grain boundaries mainly comes to be a cubic crystal structure.

By optimizing the range of the aging temperature, it is possible to increase the content of cubic crystal after aging from the content before aging and increase the coercive force. The aging temperature is desirably higher than the temperature at which rhombohedral crystal transforms into cubic crystal and it is necessary to apply aging on the temperature side higher than the temperature of the exothermic peak obtained from the differential thermal analysis of oxidized fluoride. At cooling, it is desirable to cool the formed-body at a rate of 10° C./rain or higher in the vicinity of the exothermic peak temperature in order to inhibit crystal such as rhombohedral crystal having a crystal structure different from cubic crystal from growing. With regard to the magnetic properties of a sintered magnet produced through such a process, the residual magnetic flux density is 1.4 T and the coercive force is 20 kOe in the case of an untreated magnet and the residual magnetic flux density is 1.4 T and the coercive force is 30 kOe in the case of a magnet to which a solution containing 0.1 weight % Nd fluoride is applied.

### Seventh Embodiment

In the present example, Nd₂Fe₁₀ particles indefinite in shape having a tetragonal crystal structure 0.5 to 10 μm in grain size are inserted into a metal mold installed in a molding apparatus to which a magnetic field can be applied.

A film containing fluoride is grown on the magnetic particle surfaces before the insertion by using a solution containing Nd fluoride and alcohol as the solvent. The average film thickness is 1 to 5 nm. In the film containing fluoride, oxidized fluoride of amorphia or rhombohedral crystal and fluoride and oxide of crystalloid grow and the crystal structures of the oxidized fluoride and the oxide in the film change easily by heat treatment such as heating to 350° C. for removing a solvent.

Oxidized fluoride containing Nd grows partially in the film by heating and drying in an Ar gas atmosphere. It is confirmed that the crystal structure of the heated and dried oxidized fluoride changes from rhombohedral crystal to cubic crystal due to temperature rise and the structure change is recognized by the measurement of an X-ray diffraction pattern in the temperature range of 500° C. to 700° C.

Magnetic particles on the surfaces of which fluoride and oxidized fluoride accompanying such structure changes are formed are inserted into a magnetic particle inserting portion in a metal mold and a magnetic field of 5 kOe or more is applied. The crystal grain size of the oxidized fluoride increases as heating is intensified and is 1 to 10 nm at 500° C. Here, the oxidized fluoride is a compound represented by the expression NdₙOₘFₗ (here, n, m, and l are positive integers).

Meanwhile, the oxide is a compound represented by the expression MₓO_{y} (x and y are positive integers). A preliminarily-formed-body is produced by inserting magnetic particles coated with a film in which such oxidized fluoride grows by heating into a metal mold and applying a load of 0.5 t/cm² during the application of the magnetic field. The preliminarily-formed-body is heated and sintered in a vacuum. The sintering temperature is 1, 030° C. and a liquid phase containing fluoride and oxidized fluoride is formed in the preliminarily-formed-body and the preliminarily-formed-body is sintered.

After the sintering, the formed-body is heated again to 580° C. and cooled rapidly at a cooling rate of 10° C./min. Before aging treatment, a part of the fluoride reacts with oxygen contained in the magnetic particles or oxygen in the coating film and turns into oxidized fluoride. The optimum heat treating conditions are not changed much even when the oxidized fluoride contains carbon or nitrogen in the solution. Further, the magnetic properties after aging do not largely change even when another rare earth element or iron atoms are partially contained in the oxidized fluoride (NdOF) at sintering.

The crystal structure of oxidized fluoride before aging heat treatment contains a crystal structure other than a cubic crystal. With regard to an aging temperature in the final heat treatment, in order to form cubic crystal more than rhombohedral crystal, the formed-body is heated to and retained at a temperature on the side higher than the temperature at which oxidized fluoride transforms from rhombohedral crystal to cubic crystal and thereafter cooled.

By the aging heat treatment, the cubic crystal energetically stable on the high temperature side is maintained up to room temperature and hence the crystal structure of oxidized fluoride in the vicinities of grain boundaries mainly comes to be a cubic crystal structure. The lattice constant of the cubic crystal increases as temperature rises and the unit cell volume of the cubic crystal is 150 to 210 Å³. By optimizing the range of the aging temperature, it is possible to increase the content of the cubic crystal after aging more than before aging, enhance the matching of the lattice with Nd₂Fe₁₄B that is the main phase, and unevenly distribute various added elements such as Cu, Ga and Zr at grain boundaries. Further by controlling the lattice constant to an appropriate value, it is possible to control the average matching distortion from the mother phase to 1% to 10% and the coercive force increases by 5 to 20 kOe when the crystal structure of the cubic crystal is a face centered cubic lattice.

The aging temperature is desirably higher than the temperature at which rhombohedral crystal transforms into cubic crystal and it is necessary to apply aging on the side of the temperature about 10° C. higher than the temperature of the exothermic peak obtained from the differential thermal analysis of oxidized fluoride. At cooling, it is desirable to cool the formed-body at a rate of 5° C./min or higher in the vicinity of the exothermic peak temperature in order to inhibit crystal such as rhombohedral crystal having symmetry different from cubic crystal from growing.

With regard to the magnetic properties of a sintered magnet produced through such a process, the residual magnetic flux density is 1.5 T and the coercive force is 20 kOe in the case of an untreated magnet and the residual magnetic flux density is 1.5 T and the coercive force is 30 kOe in the case of a magnet to which a solution containing 0.1 weight % Nd fluoride is applied.

Although the present example is described on the basis of Nd fluoride, in the case of another fluoride too, it is possible to inhibit a residual magnetic flux density from lowering and increase a coercive force. The fluoride is a fluoride containing a rare earth element, an alkali metal element, or an alkali earth metal element.

### Eighth Embodiment

In the present example, Sm₂Fe₁₈ particles 0.5 to 10 μm in grain size are inserted into a metal mold installed in a molding apparatus to which a magnetic field can be applied.

After the insertion, the oxygen on the magnetic particle surfaces is absorbed into fluoride by using a solution having a composition in the ratio of fluorine (F) to samarium (Sm) corresponding to SmF₄. The average film thickness is 100 nm. Such fluoride as containing oxygen comes to be oxidized fluoride such as Sm(O, F) or Sm(O, F, C) and forms a film containing also an alcoholic solvent and not being dried completely. The film before alcohol as the solvent is dried out is likely to be exfoliated from the magnetic particles and hence it is possible to remove the film mainly comprising undried oxidized fluoride partially containing carbon by cleaning with alcohol.

It is possible to diffuse fluorine up to the center of the Sm₂Fe₁₈ magnetic particles as the mother phase by removing the oxidized fluoride together with the alcohol by ultrasonic cleaning in a nitrogen atmosphere, thereafter coating the magnetic particle surfaces with a solution having the composition ratio of SmF₂₋₃, and heating and drying the magnetic particles at 350° C.

When fluorine diffuses, fluorine atoms are allocated at interstitial sites as the interstices among iron and Sm atoms or substitution sites in a part of Sm₂Fe₁₈, the Curie point rises, and crystal magnetic anisotropy increases. On this occasion, the crystal structure is a Th₂Zn₁₇ or Th₂Ni₁₇ structure, some of the fluorine atoms form FeF₂ as fluoride of iron, and the fluoride of iron scatters at parts of grain boundaries and grain boundary triple points.

A preliminarily-formed-body formed by compression molding in a metal mold while a magnetic field is applied is heated and sintered in a vacuum. The sintering temperature is 700° C. and a liquid phase is formed in the preliminarily-formed-body and the preliminarily-formed-body is sintered. After sintered, the formed-body is heated again to 300° C. and then rapidly cooled. Before aging treatment, a part of the fluoride turns into oxidized fluoride by reacting with oxygen contained in the magnetic particles.

FIGS. 7A and 7B are schematic sectional views showing the structures in the vicinities of the interfaces of magnetic particles according to an example of the present invention. FIG. 7A represents the case where oxide film removing treatment is not applied to magnetic particles and FIG. 7B represents the case where oxide film removing treatment is applied to magnetic particles.

In the figures, oxidized fluoride 302 is formed on the surface of a mother phase 301 constituting the center portion of a magnetic particle and a fluorine containing iron layer 303, namely an iron layer formed by inserting fluorine atoms into a part of the crystal, is formed thereon.

In FIG. 7B, laminar oxidized fluoride 302 is formed at a part of the interface between a mother phase 301 and a fluorine containing iron layer 303. That is, a portion where the mother phase 301 constituting the center portion of a magnetic particle directly touches the fluorine containing iron layer 303 exists (the crystal contains the hetero portion in the explanation of FIG. 2).

The crystal structure of oxidized fluoride before aging contains a crystal structure other than a cubic crystal structure, rhombohedral crystal and cubic oxidized fluoride crystal are formed at an aging temperature in the final heat treatment, fluorine atoms allocated at interstitial sites come to be regularly arrayed with iron and Sm by the aging heat treatment, and the crystal of Sm₂Fe₁₇F₃ grows in the mother phase 301.

A fluorine containing iron layer 303 and iron fluoride of body centered tetragon grow at the interface with the crystal of Sm₂Fe₁₇F₃ and the area of the interface between the oxide/oxidized fluoride and the mother phase is smaller than the area of the interface between the mother phase and the iron. This is caused by oxygen absorption treatment and fluoride treatment using the above fluoride solution and is resulted from inhibiting the growth of the oxide.

When an oxide film removing process is not applied to individual magnetic particles as stated above, the oxidized fluoride 302 grows due to the uneven distribution of oxygen on the magnetic particle surfaces and is seen as a continuous film between the fluorine containing iron layer 303 and the mother phase 301.

The continuous oxidized fluoride 302 takes the structure as shown in FIG. 7A and the oxidized fluoride 302 grows at the interface between the fluorine containing iron layer 303 and the mother phase 301. Thus the interface at which the fluorine containing iron layer 303 touches the mother phase 301 decreases and hence the ferromagnetic bond between the two layers is weakened and the residual magnetic flux density does not increase.

With regard to magnetic properties of a magnet produced through the process of removing oxygen unevenly distributing on magnetic particle surfaces, the residual magnetic flux density is 2.1 T and the coercive force is 30 kOe in the case of a magnet processed with a 0.1 weight % solution. In contrast, in the case of not applying reduction treatment for removing oxygen, the residual magnetic flux density is 1.3 T. Here, it is also possible to use magnetic particles produced by the intrusion or the substitution of some of fluorine atoms before sintering as magnetic particles for a bond magnet.

Further, as Sm₂Fe₁₈ of the mother phase, a composition of a larger Fe content can be used and a ferromagnetic element such as Co may be added. It is also possible to add an intrusion type element of a small atomic radius such as B or N that is effective in accelerating the diffusion of fluorine and increasing the allocation rate to interstitial sites rather than to substitution sites by 1 to 10 atomic %. Here, the mother phase 301 and the fluorine containing iron layer 303 touching the mother phase 301 can be formed also by the ion implantation of fluorine atoms and the reaction with a fluorine gas. On this occasion, it is also necessary to decrease unevenly distributing oxygen stated above for securing a residual magnetic flux density of 1.6 T or higher.

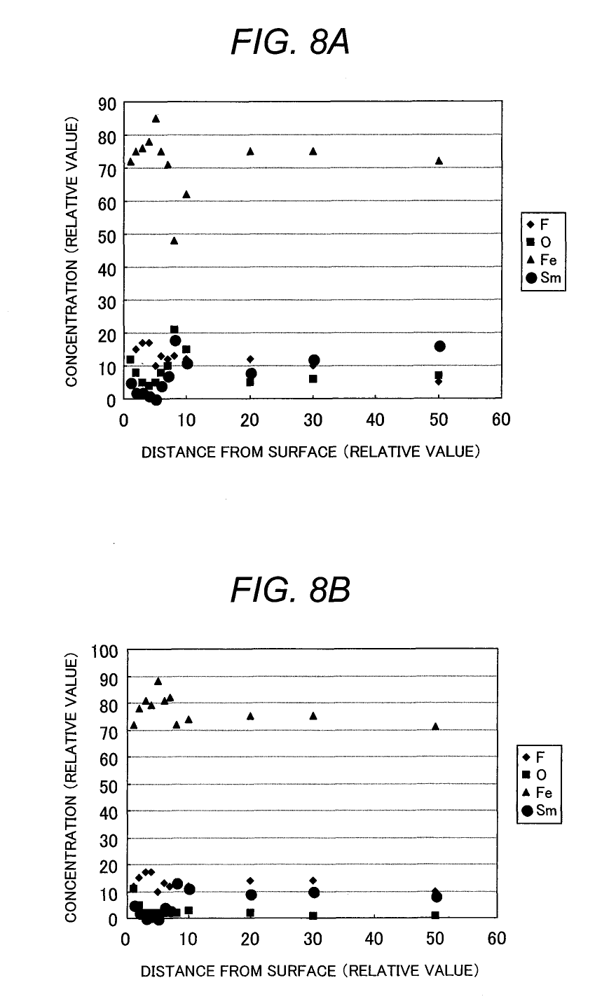

FIGS. 8A and 8B are graphs showing the distributions of elements in the vicinities of the surfaces of magnets according to an example of the present invention. That is, the figures show the results of the analyses in the depth direction in the vicinities of the surfaces of the magnets shown in FIGS. 7A and 7B by Auger electron spectroscopy. FIG. 8A is the case where oxide film removing treatment is not applied to magnetic particles and FIG. 8B is the case where oxide film removing treatment is applied to magnetic particles. The horizontal axis shows a relative value of a distance from a surface and the vertical axis shows the concentration of each atom. Here, a distance from a surface is a value based on the time of lapse when the surface of a magnet is hit with Ar ions and the concentration is a value based on the number of counts of detected atoms.

The case of a conventional process not including the process of decreasing unevenly distributing oxygen is shown in FIG. 8A. The case of removing an oxide film by using the above solution in order to decrease the quantity of unevenly distributing oxygen such as natural oxidation is shown in FIG. 8B.

Iron into which fluorine partially intrudes grows in the vicinity of a surface, Sm₂Fe₁₇F₃ as a mother phase grows in an interior, and the uneven distribution of oxygen is not recognized in the vicinity of the interface between the iron and the mother phase in the case of FIG. 8B. In contrast, in the case of FIG. 8A, the uneven distribution of oxygen is recognized in the vicinity of the interface between the iron and the mother phase. In the distribution of oxygen in the depth direction, the concentration is high in the vicinity of an interface.

It is obvious that, in the case of FIG. 8A where oxygen of a high concentration is detected, oxidized fluoride grows at the interface between the iron and the mother phase and the iron concentration in the oxidized fluoride is lower than the iron concentration in the iron and the mother phase. A part of the oxidized fluoride contains the iron and the oxidized fluoride weakens ferromagnetic bond between the iron and the mother phase, and as a result the increase of a residual magnetic flux density and the increase of a coercive force are hardly compatible.

In contrast, in the case of FIG. 8B where treatment for decreasing unevenly distributing oxygen is applied, oxygen of a high concentration (region where an oxygen concentration is high) is not detected at the interface between the iron having small Sm and ranging from the surface to 7 and the mother phase deeper than 8 from the surface. At an interface having such a composition distribution, ferromagnetic bond appears between iron and a mother phase and some of the fluorine atoms are allocated at interstitial sites of the iron and the mother phase.

Fluorine atoms allocated at the interstitial sites increase the magnetic moment of iron, a residual magnetic flux density increases by ferromagnetic bond at an interface, and a coercive force increases by the increase of crystal magnetic anisotropy energy caused by lattice distortion and the change of electron distribution. Here, even when some of fluorine atoms are allocated at substitution sites, similar effects can be confirmed and it is possible to introduce fluorine atoms into interstitial sites by the reaction of gaseous fluorine or an ion implantation technique other than the processing with a solution.

### Ninth Embodiment

In the present example, fluorine ions are implanted into Sm₂Fe₁₈ particles 0.1 to 5 μm in grain size. The quantity of the implantation is 1×10¹⁴ to 1×10¹⁸/cm². The Sm₂Fe₁₈ particles are rotated during the implantation and fluorine ions are implanted from the whole surfaces of the particles.

By the ion implantation, the concentration gradient of fluorine is formed from the particle surfaces to the interiors, some of the fluorine atoms are allocated at interstitial sites in a lattice, and the interatomic distance of iron expands. When the implantation quantity exceeds 10¹⁸/cm², the fluorine atoms grow as SmF₃ and FeF₃ that are stable fluoride with Sm and Fe, and the residual magnetic flux density lowers. In contrast, when the implantation quantity is less than 10¹³/cm², the increase of the residual magnetic flux density as the introduction effect of fluorine atoms is less than 10% and the implantation quantity is not an optimum quantity.

When the implantation quantity is in the range of 1×10¹⁴ to 1×10¹⁸/cm², the increase of the residual magnetic flux density is 10% to 20% in comparison with the residual magnetic flux density before implantation and the Curie temperature rises by 390° C. from 130° C. to 520° C. In such ion implanted Sm₂Fe₁₈ particles, besides iron of a bcc or bct structure, an Sm₂Fe₁₇F₃ phase into which fluorine intrudes grows, fluorine is abundant on the outer circumference side of the particles, and the Curie temperature and the crystal magnetic anisotropy increase on the outer circumference side. By mixing such particles with an organic material and applying compression or injection molding, a bond magnet can be produced and various surface magnet rotors or embedded magnet rotors can be fabricated.

### Tenth Embodiment

In the present example, fluorine ions and nitrogen ions are simultaneously implanted into Sm₂Fe₁₇ particles 0.1 to 5 μm in particle size. The total quantity of the implanted ions is in the range of 1×10¹⁴ to 1×10¹⁸/cm². The implantation condition of the ion source is adjusted so that the ratio F/N of the fluorine ions to the nitrogen ions may be 1±0.2 (namely, in the range of 0.8 to 1.2). The particles are rotated or vibrated during the implantation and the fluorine ions are implanted from the whole surfaces of the particles.

By the ion implantation, the concentration gradient of fluorine is formed from the particle surfaces to the interiors, some of the fluorine atoms are allocated at interstitial sites in a lattice, and the interatomic distance of iron expands. When the implantation quantity exceeds 10¹⁸/cm², the fluorine atoms grow as SmF₃ and FeF₃ that are stable fluoride with Sm and iron, Fe₄N as a nitrogen compound grows, and the coercive force lowers.

In contrast, when the implantation quantity is less than 10¹³/cm², the increase of the residual magnetic flux density as the introduction effect of fluorine atoms and nitrogen atoms is less than 10% and the implantation quantity is not an optimum quantity. When the implantation quantity is in the range of 1×10¹⁴ to 1×10¹⁸/cm², the increase of the residual magnetic flux density is 10% to 20% in comparison with the residual magnetic flux density before implantation and the Curie temperature rises by 370° C. from 130° C. to 500° C.

In such ion implanted Sm₂Fe₁₈ particles, besides iron of a bcc or bct structure, an Sm₂Fe₁₇(F, N)₃ phase into which nitrogen and fluorine intrude grows, fluorine and nitrogen are abundant on the outer circumference side of the particles, and the Curie temperature and the crystal magnetic anisotropy increase on the outer circumference side.

A bond magnet having a residual magnetic flux density of 1.1 T can be produced by mixing such particles with an organic material and applying compression or injection molding. It is possible to give anisotropy by forming in a magnetic field, and a surface magnet rotor or an embedded magnet rotor can be fabricated. Here, even if some of fluorine atoms or nitrogen atoms are substituted at the sites of iron (Fe) and samarium (Sm) atoms, the magnetic properties are not largely affected as long as the concentration is 1 atomic % or lower.

Although the atoms other than iron atoms implanted into magnetic particles are fluorine and/or nitrogen in the above examples, the atoms are not limited to those elements and some or all of the atoms other than the iron atoms may be an element selected from the group consisting of fluorine, nitrogen, boron, carbon and oxygen.

The present invention makes it possible to increase the residual magnetic flux density and the coercive force of a rare earth magnet and heighten the Curie temperature thereof.

A magnet according to the present invention can satisfy a high coercive force, a high magnetic flux density, a high resistivity, and the like and can be used for a drive motor of a hybrid automobile or another motor that uses a magnetic circuit of a high thermal resistance and a low loss (a high efficiency).

The present invention relates to a sintered magnet in which a phase containing fluorine (a fluorine containing phase) is formed at parts of the grain boundaries or the interiors of the particles of an Fe system magnetic material in order to enhance thermal resistance of a magnet of an Fe system including an R—Fe system (R represents a rare earth element) and the magnetic properties and reliability are improved by the fluorine containing phase; and a rotor using the sintered magnet. A magnet having a fluorine containing phase can be used for a magnet having properties conforming to various magnetic circuits and a magnetic motor and the like using the magnet.

Such magnetic motors include magnetic motors for the drive of a hybrid automobile, a starter, and an electric power steering. The computation result on Gd₂Fe₁₇F₃ in which fluorine atoms are allocated at interstitial sites is described in Non-Patent Literature 1. It is understood from the computation result that, by allocating fluorine atoms at interstitial sites, the magnetic moment comes to be larger than the case of nitrogen atoms.

What is claimed is:

1. A magnet formed by compressing magnetic particles, wherein a surface of the magnetic particles is covered with a metal fluoride film; the magnetic particles have a crystal structure containing a homo portion formed by bonding adjacent iron atoms and a hetero portion formed by bonding two iron atoms via an atom other than iron; and a distance between the two iron atoms in the hetero portion is different from a distance between the adjacent iron atoms in the homo portion.

2. A magnet according to claim 1, wherein the hetero portion contains an element selected from the group consisting of fluorine, boron, carbon, nitrogen and oxygen.

3. A magnet according to claim 1, wherein the magnetic particles contain a rare earth element.

4. A magnet according to claim 1, having a structure formed by touching a mother phase constituting a center portion of the magnetic particles directly to a crystal containing the hetero portion.

5. A magnet according to claim 1, wherein the metal fluoride film contains a fluoride of an element selected from the group consisting of rare earth elements, alkali metal elements and alkali earth metal elements.

6. A magnet according to claim 4, wherein a concentration of the atom other than iron contained in the mother phase is higher at an outer circumferential portion of the mother phase than at a center portion of the mother phase.

7. A rotor comprising a magnet according to claim 1.

8. A rotor according to claim 7, wherein a concentration of the atom other than iron at an outer circumferential portion of the magnet is higher than that of the atom other than iron at an inner circumferential portion of the magnet.

9. A rotor according to claim 7, wherein a magnetic flux density at the outer circumferential portion of the magnet is higher than that at the inner circumferential portion of the magnet.

10. A rotor according to claim 7, wherein a magnetic flux density and a coercive force at the outer circumferential portion of the magnet are higher than those at the inner circumferential portion of the magnet.

11. A motor comprising a magnet according to claim 1.

12. A motor comprising a rotor according to claim 7.

13. A rotary electrical apparatus comprising a magnet according to claim 1.
